(19) United States
(12) Patent Application Publication
(10) Pub. No.: US 2004/0076706 A1
(43) Pub. Date: Apr. 22, 2004

(54) Mold station

(76) Inventor: Peter Walther, Hille (DE)

Correspondence Address: Schwartz Law Firm, P.C., 6100 Fairview Road, Charlotte, NC, 28210, US

(21) Appl. No.: 10/350,736

(22) Filed: Jan. 23, 2003

(30) Foreign Application Priority Data
Oct. 16, 2002 (DE) 202 15 921.3

(51) Int. Cl. B29C 51/42

(52) U.S. Cl. 425/384; 425/387.1

(57) ABSTRACT

A mold station for hot shaping plate-shaped polymer-bound plastics, thermoplastics, mineral plastics, into three-dimensional molded bodies such as bathtubs, sinks, washbasins, washstands, facings and shields, furniture parts, work surfaces, window sills and the like with a mold arrangement accommodated in a frame and in which are located at least one mold part for receiving the material to be molded, a membrane clamped over the mold part. The membrane is substantially impermeable to gas and elastically stretchable. A pressure difference is generated between the two sides of the membrane, characterized by the additional provision in the frame of the mold arrangement of a heating or cooling arrangement with two plate-shaped heating or cooling elements for pre-tempering of the material to be molded that can move in two directions that are substantially vertical with respect to each other.

### TECHNICAL FIELD AND BACKGROUND OF THE INVENTION

This invention relates to a mold station for hot shaping, in particular, of plate-shaped polymer-bound plastics, thermoplastics, mineral plastics, etc. into three-dimensional molded bodies with a frame accommodating a molding arrangement in which are arranged at least one mold part for receiving the material to be molded, a membrane which is clamped over the mold part, substantially impermeable to gas and elastically stretchable, as well as means to generate a pressure difference between the two sides of the membrane.

Previously, plate-shaped material made of plastic has been pressed into a molded body, for example, by subjecting it between two dies made of metal or wood to the pressure of a hydraulic press. This process is expensive because the dies must have a structure that is very stable and a surface that is extremely precise. Aluminum molds with polished surfaces are used for the most part here. Because of the high costs, this compression molding is suitable only for large quantity production such as of washbasins.

Vacuum forming represents a more economical alternative to this compression molding. In this process, the plate-shaped material is subjected in the mold arrangement to a vacuum and is thus pressed into the mold part. The advantage here lies in the easy application and low die costs giving the potential for economical production of small lots or individual units as well. So-called mineral plastics such as “Corian”™ made by Dupont and “Quaryl”™ produced by Villeroy & Bosch have recently been marketed, particularly for the manufacture of sanitary items such as bathtubs, sinks, washbasins, washstands, facings and shields, but also of furniture parts, work surfaces, window sills and the like.

A prerequisite for vacuum forming of such plastics is that they are heated sufficiently before being subjected to the shaping process in order to enhance their plastic deformability. However, when heating is carried out in the vacuum mold, the cycle times for producing such three-dimensional molded bodies increase considerably and so it is quite difficult to carry out economical manufacturing in quantity with this process.

A known alternative to this is first to pre-heat the plate-shaped plastics to be molded to a temperature suitable for molding in a separate pre-heating station and only then to insert them into the vacuum mold. Such pre-heating stations are separate units set up if possible near the vacuum mold. This makes it possible to attain shorter cycle times in the vacuum mold itself. A drawback with this process, however, is that the heated and relatively soft plastic plates must be conveyed out of the pre-heating station and into the vacuum mold which necessarily means a cooling of the plastic plates. Moreover, the heated plastic plates can be damaged during the move. In addition, the space requirement increases considerably with this process because two separate arrangements for heating and shaping the plastic plates are to be provided.

### SUMMARY OF THE INVENTION

Therefore, it is an object of the invention to provide a mold station of the type mentioned in the beginning in which three-dimensional molded bodies can be produced in short cycle times while avoiding the above-mentioned drawbacks of the known processes.

The invention achieves this object by a mold station characterized by the additional provision in the frame thereof of a heating or cooling arrangement with two plate-shaped heating or cooling elements for pre-tempering of the material to be molded which can move in two directions which are substantially vertical with respect to each other. The invented design of the mold station is thus the first combination in a single frame of a mold arrangement and a heating or cooling arrangement. The space requirement of this mold station is consequently almost identical with that of a conventional vacuum mold without an additional heating or cooling arrangement. The additional heating or cooling arrangement in the frame of the mold arrangement also permits heating of the material to be molded before the actual shaping process and/or a cooling of the molded part after the vacuum molding process. This eliminates the need for conveying the material to be molded or the molded body over long distances. Material to be molded or the molded body can rather be brought by the shortest route out of the heating or cooling arrangement into the mold arrangement or vice versa. The separation in the frame of the heating or cooling arrangement from the mold arrangement also makes it possible to remove the two arrangements from the frame separately from each other, for example, for servicing or repair purposes.

In one preferred embodiment of the invention, one of the plate-shaped heating or cooling elements is designed as a displacement table which can be withdrawn from the frame in the horizontal direction to receive the material to be molded. This considerably facilitates insertion of objects into the heating or cooling arrangement.

In a further development of the invention, one of the plate-shaped heating or cooling elements is arranged to move in the vertical direction in the frame. In this way, the object to be tempered can be made to approach closely to the two heating or cooling elements so that rapid heating or cooling is possible.

An especially economical development of the mold arrangement of the mold station is obtained when the pressure difference between the two sides of the membrane is generated by a vacuum pump. In addition or as an alternative to this, the membrane can be loaded on one side with compressed air or the like.

The frame will preferably be provided with a further heating or cooling arrangement associated with the mold. This makes it possible, even during the shaping process in the mold arrangement, to heat the material to be molded to enhance deformability or to cool it already during the shaping process.

In a preferred embodiment of the invention, the first heating or cooling arrangement with the plate-shaped heating or cooling elements which is separate from the mold arrangement, is placed vertically under the mold arrangement in the frame. In this case, the mold arrangement is in an ergonomically favorable position which makes it easy to operate the mold station. The heating or cooling arrangement located directly under the mold arrangement provides for easy access. The one over the other positioning of the mold arrangement and the heating or cooling arrangement also minimizes the surface area needed for installation of the mold station.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 shows the closed mold station in a sectional view from the side, and

FIG. 2 shows the opened mold station in a sectional view from the side.

### DESCRIPTION OF THE PREFERRED EMBODIMENTS AND BEST MODE

Referring now specifically to the drawings, a mold station 1 shown in the figures has a frame 2 containing a mold arrangement 3 and a heating or cooling arrangement 4 located under the mold arrangement 3.

The mold arrangement 3 is designed as vacuum molding arrangement with a vacuum pump 5. The vacuum pump 5 is connected by means of a number of channels to a suction plate 6. Mold parts (not shown) can be arranged on the suction plate 6 in order to give the desired contour to the material to be molded. Stretched over a preferably torsionally rigid vacuum frame 7 mounted to swivel on the frame 2 is a substantially gas-impermeable and elastically stretchable membrane 8. When the vacuum pump 5 produces a vacuum in the suction plate 6, the membrane is pressed by the vacuum firmly on a mold part arranged on the suction plate 6 and on the material to be molded arranged thereon, this producing a three-dimensional molded body.

The heating or cooling arrangement 4 is provided with a top heating or cooling plate 9 and a bottom heating or cooling plate 10. The top heating or cooling plate 9 can be displaced in the frame 2 vertically relative to the bottom heating or cooling plate 10, for example, by means of pneumatic short-stroke cylinders 11. The top heating or cooling plate 9 can thus be lowered onto a plate-shaped plastic material deposited on the bottom heating or cooling plate 10, which holds the plastic material down level. In order to keep the plate-shaped plastic material from being pressed thereby, it is possible to pre-adjust the material thickness by means of adjusting screws so that the top and bottom heating or cooling plates can be approached to one another to within only a predetermined distance.

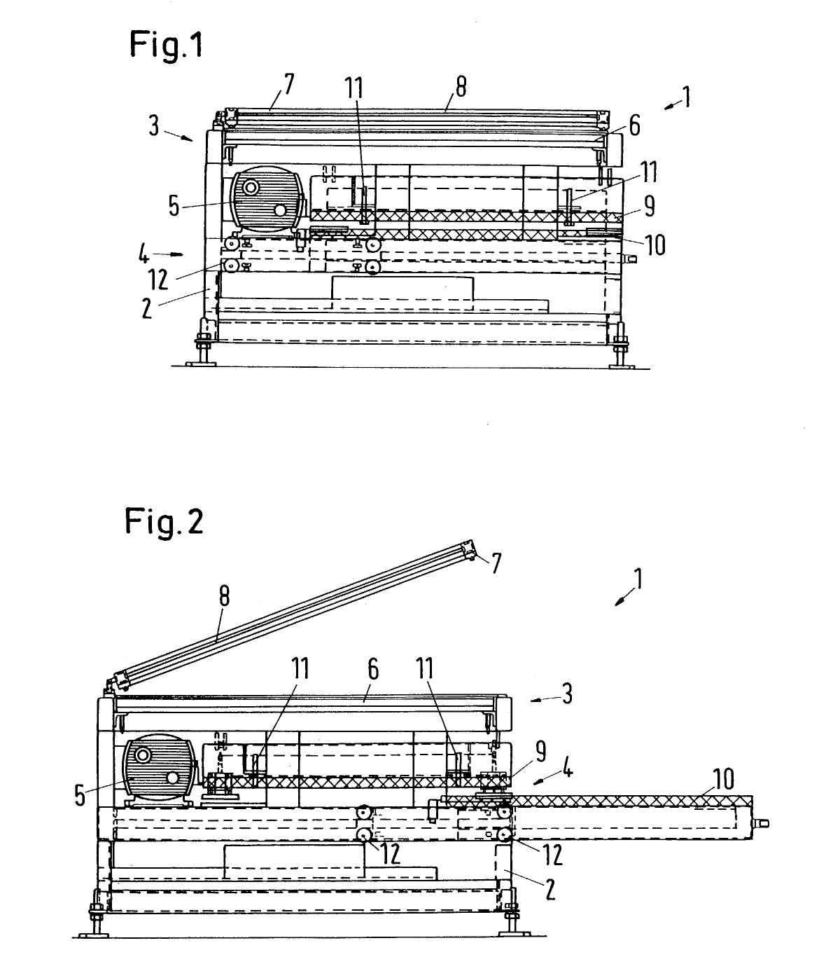

The bottom heating or cooling plate 10 is mounted on a number of rollers 12 and can thus be withdrawn from the frame 2 horizontally as a displacement table from the position shown in FIG. 1 to the position shown in FIG. 2. A plastic plate to be heated can thus be simply placed on the heating or cooling plate 10 and run into the heating or cooling arrangement 4. In this case, the heating or cooling arrangement 4 is suitable both for heating a workpiece before the shaping process or for cooling a molded body after the shaping process.

The production of a three-dimensional molded body made, for example, of a mineral plastic plate takes place in the mold station 1 in that the bottom heating or cooling plate 10 designed as a displacement table is first withdrawn from the frame 2 so that the plate made of mineral plastic can be placed thereon. Both the top and bottom heating and cooling plates 9, 10 are heated so that the material to be molded is heated after the mineral plastic plate is pushed onto the bottom heating or cooling plate 10. To this the top heating and cooling plate 9 is lowered so that the heat can have an effect on both sides of the mineral plastic plate.

At the end of the pre-heating time, the top heating or cooling plate 9 can be lifted by the short-stroke cylinder and the bottom heating or cooling plate 10 can be withdrawn from the frame 2. The pre-heated mineral plastic plate is then placed onto a mold part on the suction plate 6 and the vacuum frame 7 is closed off with the membrane 8.

As soon as the vacuum pump has produced a vacuum, the membrane is pressed onto the heated mineral plastic plate to shape it. The mineral plastic plate can be cooled at the same time in this case so that a three-dimensional molded body can be removed in a cooled and solid condition from the mold arrangement 3 at the end of the shaping process.

### Reference Numerals

1 Mold station

2 Frame

3 Mold arrangement

4 Heating or cooling arrangement

5 Vacuum pump

6 Suction plate

7 Vacuum frame

8 Membrane

9 Top heating or cooling plate

10 Bottom heating or cooling plate

11 Short-stroke cylinder

12 Roller

A mold station is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A mold station for hot shaping, in particular, of plate-shaped plastics, such as polymer-bound plastics, thermoplastics, mineral plastics, into three-dimensional molded bodies such as bathtubs, sinks, washbasins, washstands, facings and shields, furniture parts, work surfaces, window sills and the like with a mold arrangement (3) accommodated in a frame (2) and in which are located at least one mold part for receiving the material to be molded, a membrane (8) clamped over the mold part, said membrane being substantially impermeable to gas and elastically stretchable, and generating means (5, 6) to generate a pressure difference between the two sides of the membrane, characterized by the additional provision in the frame (2) of the mold arrangement (3) of a heating or cooling arrangement (4) with two plate-shaped heating or cooling elements (9, 10) for pre-tempering of the material to be molded, which can move in two directions which are substantially vertical with respect to each other.

2. Mold station as described in claim 1, characterized in that one of the plate-shaped heating or cooling elements (9, 10) is designed as a displacement table (10) which can be withdrawn horizontally from the frame (2) for receiving the material to be molded.

3. Mold station as described in claim 1 or 2, characterized in that one of the plate-shaped heating or cooling elements (9, 10) can be displaced vertically in the frame (2).

4. Mold station as described in claim 1 or 2, characterized in that the means (5, 6) for producing a pressure difference between the two sides of the membrane (8) comprises a vacuum pump.

5. Mold station as described in claim 1 or 2, characterized in that a further heating or cooling arrangement associated with the mold arrangement (3) is provided in the frame (2).

6. Mold station as described in claim 1 or 2, characterized in that the first heating or cooling arrangement (4) with the two plate-shaped heating or cooling elements (9, 10) for pre-tempering of the material to be molded is located vertically under the mold arrangement (3) in the frame (2).
